(19) United States
(12) Patent Application Publication
(10) Pub. No.: US 2018/0155972 A1
(43) Pub. Date: Jun. 7, 2018

(54) EJECTION DEVICE FOR A MOVABLE FURNITURE PART

(71) Applicant: HETTICH-ONI GMBH & CO. KG, Vlotho (DE)

(72) Inventor: Karsten FILGES, Bielefeld (DE)

(21) Appl. No.: 15/570,424

(22) PCT Filed: Apr. 26, 2016
(86) PCT No.: PCT/EP2016/059274

§ 371 Date: Oct. 30, 2017

(30) Foreign Application Priority Data
Apr. 30, 2015 (DE) 10 2015 106 781.1

(51) Int. Cl. E05F 1/10; E05C 19/16; E05F 3/00; E05F 5/02

(52) U.S. Cl. CPC E05F 1/105; E05C 19/165; E05Y 2900/20; E05F 5/02; E05F 3/00

(57) ABSTRACT

The invention relates to an injection device for a movable furniture part, in particular a door or a flap, which injection devices comprises an ejection element, which can be coupled to a movable furniture part and which is provided for moving the movable furniture part into an open position, a releasable locking mechanism, by means of which a force accumulator for actuating the ejection element can be locked in a closed position of the furniture part, a loading device for loading the force accumulator after the actuation of the ejection element by means of movement of the furniture part in the opening direction, a retracting device for the ejection element, by means of which the ejection element can be moved in the closing direction after the ejection element has been decoupled from the furniture part, wherein the locking mechanism has a first linearly movable slide, the loading device has a second movable slide, the ejection element-is connected to a third slide, and the second slide and the third slide can be moved in the opening direction by means of the first slide.

### CROSS REFERENCE TO RELATED APPLICATIONS

This application is a U.S. nationalization under 35 U.S.C. § 371 of International Application No. PCT/EP2016/059274, filed Apr. 26, 2016, which claims priority to German Application No. 102015106781.1 filed Apr. 30, 2015.

### BACKGROUND AND SUMMARY OF THE DISCLOSURE

The present disclosure relates to an ejection device for a movable furniture part, in particular a door or a flap, comprising an ejection element which can be coupled to a movable furniture part for moving the movable furniture part into an open position, a releasable latching mechanism by means of which an energy storage device for actuating the ejection element is latchable in a closed position of the furniture part, a tensioning device for tensioning the energy storage device after the actuation of the ejection element by moving the furniture part in the opening direction, a retracting device for the ejection element, by means of which, after decoupling of the ejection element from the furniture part, the ejection element can be moved in the closing direction.

DE 10 2011 052 355 A1 discloses a device for opening a cabinet door of a piece of furniture. By pressing in the cabinet door, a latching mechanism is unlocked to move the cabinet door into an intermediate position. From this intermediate position, the cabinet door can then be pulled open manually, wherein an ejector piston is retracted against the force of a pressure spring by way of a tensioning rod which is coupled to the cabinet door. After releasing the cabinet door from the tensioning rod, it can then also be moved back into a cabinet body. However, it is not shown how the control unit is to transmit the movement of the tensioning rod to the ejector piston. In addition, it is not shown how the individual units can be installed in a compact manner.

An ejection device in accordance with the disclosure comprises a releasable latching mechanism, by means of which an energy storage device for actuating an ejection element can be latched into a closed position of the furniture part, wherein the latching mechanism has a first linearly displaceable slide and a tensioning device for tensioning the energy storage device and a second movable slide. The ejection element is connected to a third slide, and the second slide and the third slide are movable in the opening direction via the first slide. As a result, linear traversing movements can be carried out by the slides in order to tension the energy storage device or to move the ejection element. The linear guidance through the slides enables the provision of high ejection forces and a high precision with respect to the movement sequences. In addition, the slides can be accommodated in compact design in a common housing.

In an embodiment, the second slide is movable in the closing direction by the retracting device via the third slide. As a result, the first slide can move the second slide in the opening direction, and the third slide can move the second slide in the closing direction, wherein the second slide is preferably arranged between the first and third slide.

In an embodiment, the three slides are linearly guided within a common housing. For such linear guidance, grooves can be formed on the housing on a side facing the inner space for guiding the slides, so that precise guidance is ensured. The housing can be made, for example, of metal, in particular an extruded aluminum profile. Other materials such as plastics are also possible.

The tensioning device may have a gear for moving the first slide in the closing direction when the third slide is withdrawn in the opening direction. The third slide and the first slide thus move in opposite directions, while the second slide remains stationary in an end position. The gear can in this case have a clutch in order to be able to move the second and third slide in the closing direction in the decoupled position. For engaging the gear, a gearwheel can be held movable perpendicularly to the axis of rotation, in particular the gearwheel of the gear can be coupled in by moving the third slide after the ejection movement in the opening direction.

In a further embodiment, a latching mechanism is provided, on which a guide track with a loop-shaped section and a catch recess is arranged, into which a control pin engages, which can be latched onto the guide track. The latching mechanism can be connected to the first slide in such a way that it can be latched in the initial position against the force of the energy storage device.

In an embodiment, the retracting device has a damper so that a return movement of the second and third slide can take place with low speed and low stop noises. The damper can be designed in this case as a rotary damper, which is driven via a toothed rack, which is fixed for example to the housing and is in engagement with a toothed wheel for driving the rotary damper. The rotary damper can move in this case on the third slide since this has the longest travel path in the closing direction.

The energy storage device may comprise at least one linearly guided spring, in particular a compression spring. Depending on the required force, several springs can also be used for the energy storage device. The spring force of the energy storage device is greater in this case than the force of a spring of a retracting device since this only has to move the second and third slide from an open position into the closed position.

A magnet may be provided on the ejection element, which can be coupled to a driver on a door or flap via magnetic forces. It is also possible to connect the ejection element to the door or the flap by means of a mechanism in order to be able to move the ejection element in the opening direction via tensile forces for tensioning the energy storage device.

The ejection device according to the disclosure is preferably used in a piece of furniture in which at least one door is pivotably mounted via one or more hinges. However, it is also possible to use said device for household appliances, flaps or other movable furniture parts.

### BRIEF DESCRIPTION OF THE DRAWINGS

FIG. 1 shows a schematic view of a piece of furniture with an ejection device according to the invention;

FIG. 2 shows a perspective view of the ejection device of FIG. 1 with the housing partially removed;

FIG. 3 shows an exploded perspective view of the ejection device of FIG. 1;

FIGS. 4A and 4B show two views of the ejection device of FIG. 3;

FIGS. 5A and 5B show two views of the ejection device of FIG. 3 in an intermediate position, and

FIGS. 6A to 6C show several views of the ejection device of FIG. 3 in an end position with the ejection element fully extended.

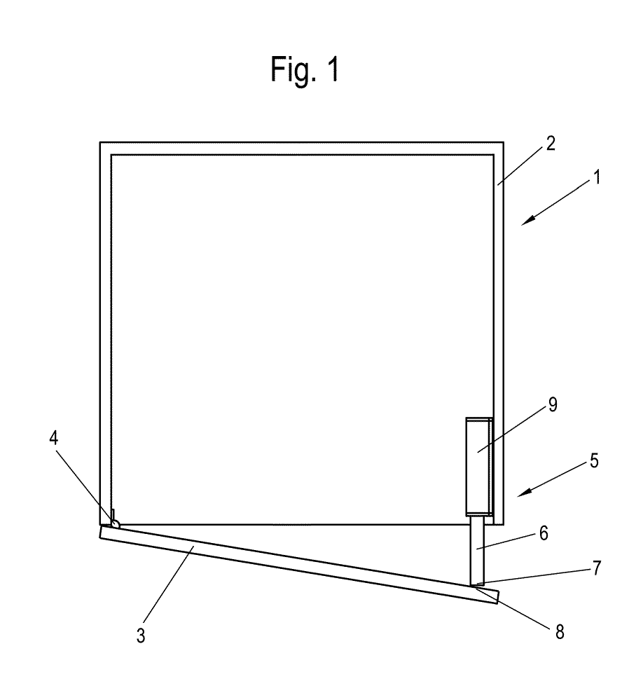

### DETAILED DESCRIPTION OF THE DRAWINGS

A piece of furniture 1 comprises a furniture body 2, to which a door 3 is pivotably mounted via one or more hinges 4. On the side opposite the hinges 4, the door 3 is ejected into a slightly opened open position via an ejection device 5, e.g. into an open position between 30 mm and 50 mm spaced from the closed position. For ejecting the door 3, the ejection device 5 comprises a rod-shaped ejection element 6, which can be coupled to the door 3 via a magnet 7 with a driver 8. As a result, when the door 3 is opened from the intermediate position, a pulling force can be transmitted to the ejection element 6 so as to tension a tensioning device within a housing 9 of the ejection device 5 against the force of an energy storage device. As soon as the energy storage device is tensioned and fixed in the tensioned position by means of a latching mechanism, the coupling between the ejection element 6 and the door 3 can be released so that the door 3 can then be pivoted independently of the ejection device 5. At the same time, the ejection element 6 moves back into the housing 9 by means of a retracting device so that the door 3 can automatically be closed again via retracting springs of the hinges 4 in a closing movement without the ejection device 5 hindering the closing process. In order to open the door 3, the door 3 can then be slightly pressed in the closing direction in order to press in the ejection element 6 and thereby unlock a latching mechanism so that the ejection element 6 can then again eject the door 3 into the slightly opened open position.

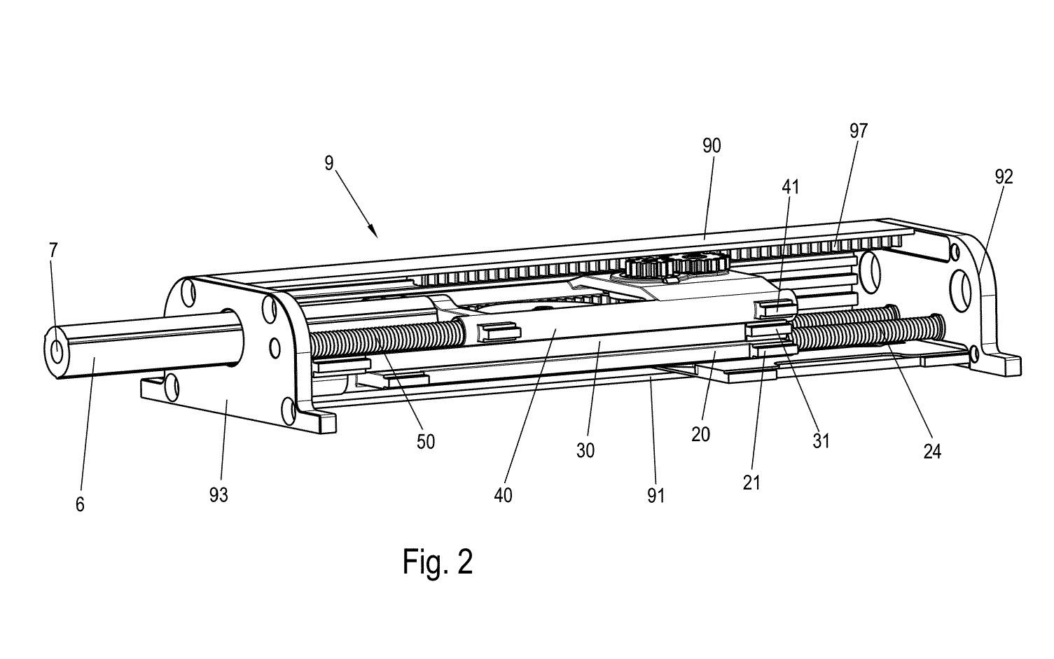

FIG. 2 shows the ejection device 5 with the housing 9. The housing 9 comprises an upper housing shell 90 and a bottom 91, which can be produced from one part, for example an extruded hollow profile, or are composed of several parts. The housing shell 90 and the bottom 91 are closed at opposite ends by cover caps 92 and 93, wherein the ejection element 6 is passed through an opening 98 via the cover cap 93. Within the housing 9, a first slide 20 is mounted in a linearly movable manner, which is pretensioned via an energy storage device 24 in the form of two compression springs, wherein the compression springs are supported on the cover cap 92 on the side remote from the first slide 20. Adjacent to the first slide 20, a second slide 30 is mounted to be displaceable parallel to the first slide 20, wherein the second slide 30 is arranged between the first slide 20 and a third slide 40. In this case, the third slide 40 is pretensioned in the closing direction by an energy storage unit 50 of a retracting device, wherein the energy storage device 50 is designed as a compression spring and is supported on the cover cap 93 on the side which faces away from the third slide 40.

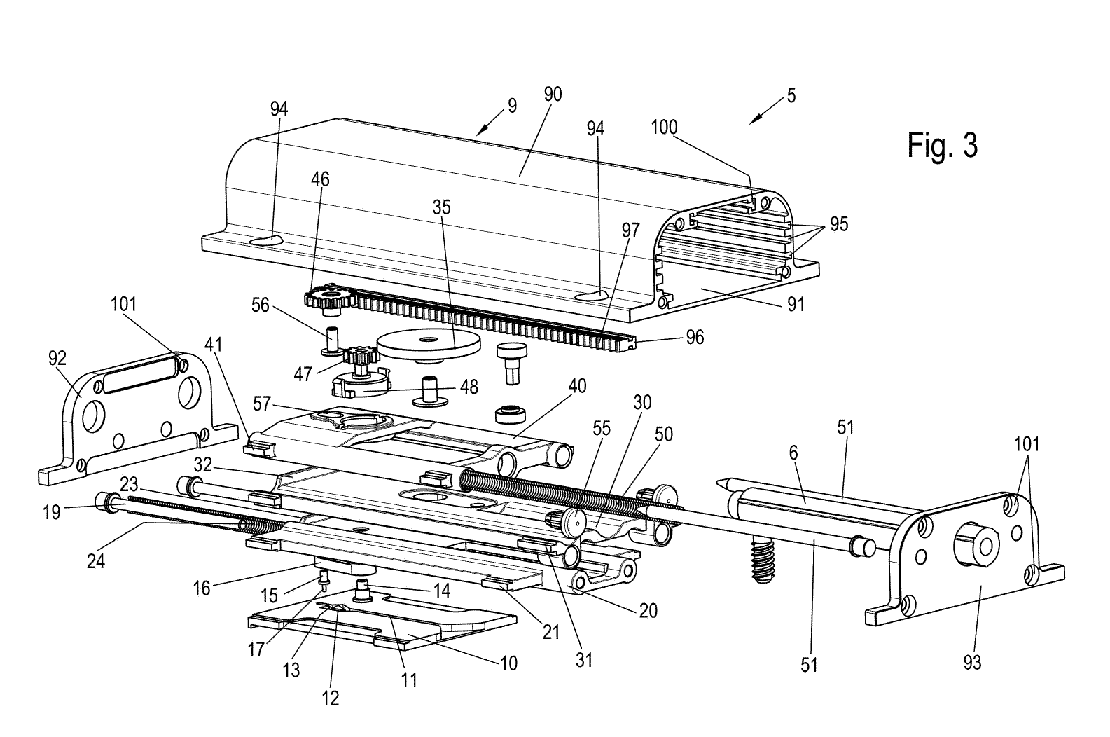

FIG. 3 shows the ejection device 5 in an exploded view.

The housing 9 is designed as a hollow profile and has, on opposite sides, grooves 95, which serve to guide the slides 20, 30 and 40. For this purpose, webs 21 which engage into a first groove 95 are formed on opposite sides of the slide 20, and in a similar manner projecting webs 31 are formed on the second slide 30 and webs 41 are formed on the third slide 40, which each engage in a second and third groove 95 on the housing 9. The slides 20, 30 and 40 are guided in the grooves 95 linearly adjacent to one another.

For fixing the cover caps 92 and 93, screw channels 99 are provided on the housing 9, so that larger forces can also be absorbed in the direction of movement of the slides 20, 30 and 40 via the cover caps 92 and 93. The housing 9 comprises openings 94 on laterally protruding webs, by means of which the housing 9 can be fastened via fastening means to a side wall of a furniture body. Apart from the housing 9, only the ejectable ejection element 6 is visible in the mounted position. In the cover caps 92 and 93, openings 101 are also provided for the passage of fastening means.

A groove 100 is formed on the housing shell 90, into which a foot portion 96 of a toothed rack 97 is inserted. The toothed rack 97 is fixed to the housing 9 and is in engagement with a gearwheel 46, which is rotatably mounted on a shaft 56, wherein the shaft 56 is displaceably arranged on an elongated hole 57 of the third slide 40. The gearwheel 46 is in engagement with a gearwheel 47, which drives a rotary damper 48, at least during a closing movement of the third slide 40. In the opening direction, the gearwheel 47 can be decoupled from the gearwheel 46 so that the rotary damper 48 is ineffective in the opening direction. Alternatively, the rotary damper can also be permanently coupled directly to the toothed rack 97 via a gearwheel, wherein the rotary damper only dampens in the closing direction. Another alternative for the dampened retracting device may be a system with a linear damper that dampens the movement of the slide 40 in the closing direction.

The third slide 40 has a tubular receptacle into which pins 51 engage. The spring 50 is arranged around the pins 51, which spring pretensions the slide 40 into the closed position. The pins 51 and the tubular receptacle serve to prevent the compression spring 50 from buckling. Alternatively, the energy storage device for the retracting device can also be designed as a tension spring, roller spring, etc., wherein the tension spring could be connected on the other side of the housing for example.

Two pins 19 are also fixed to the cover cap 92 on the opposite side of the housing 9, around which in each case one spring is arranged as an energy storage device 24 in order to pretension the first slide 20 in the opening direction. On the first slide 20, the energy storage device is guided in sleeves 22, similar to the third slide 40. In this case too, the spring 24 is embodied as a compression spring, wherein the energy storage unit 24 for the ejection device can also be designed as a tension spring, roller spring, etc., wherein the tension spring, for example, could be attached to the other side of the housing. A pivotable lever 16 is also provided on the first slide 20, which lever has a control element 15 with a pin 17. The pin 17 of the control element 15 engages in a guide track 11 on a plate 10, which is fixed to the bottom 91 of the housing 9. The groove-shaped guide track 11 has a loop-shaped section 12 with a catch recess 13, on which the control element 15 can be latched with the pin 17 against the force of the energy storage device 24. Such a guide track 11 is also known as a “heart curve”. When the ejection element 6 is pushed in by the door 3, the third slide 40 moves against the second slide 30 and the second slide 30 moves against the first slide 20, so that the first slide 20 is slightly moved in the closing direction, wherein the latching mechanism is unlocked on the guide track 11. Thus, the energy storage device 24 can now act on the first slide 20 so that it is moved in the ejection direction. A web-shaped driver 23 is provided on the first slide 20, which driver rests against an end edge of the second slide 30 and moves the latter in the opening direction. Furthermore, a web-shaped driver 32 is also provided on the second slide 30, which rests against an end edge of the third slide 40 and moves the latter in the opening direction. The third slide 40 is connected to the ejection element 6, which is thus moved in the opening direction by the energy storage device 24.

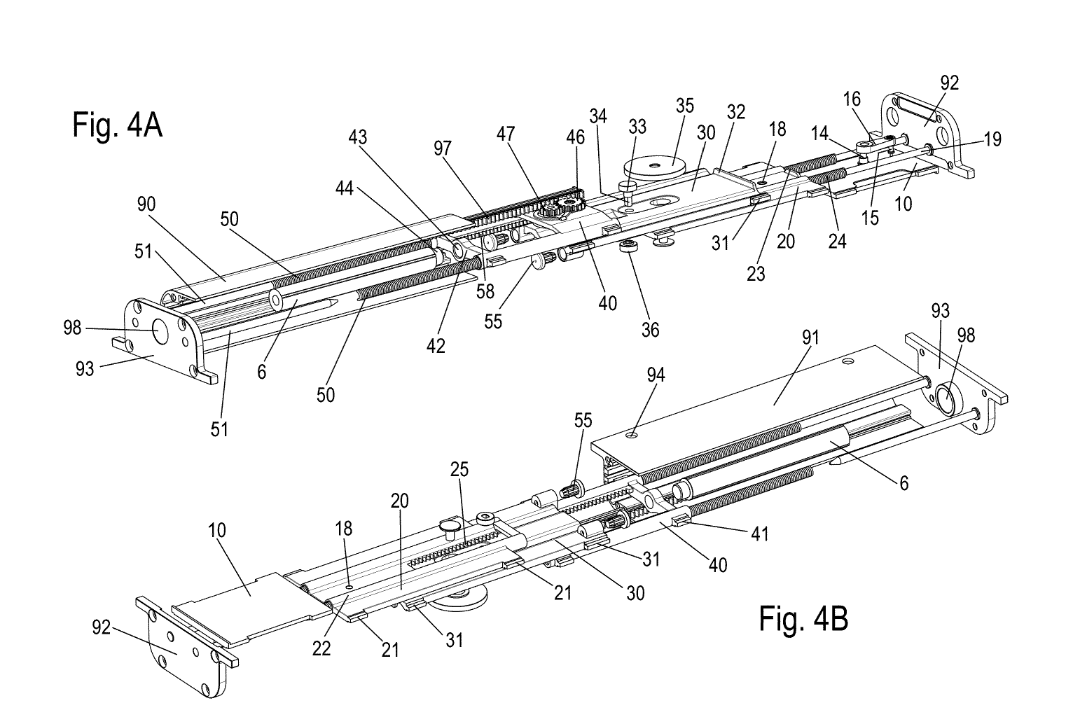

In FIGS. 4A and 4B, the ejection device is shown in two perspective views. An opening 18 is positioned on the first slide 20 for bearing a pin 14, on which the lever 16 is rotatably mounted. The lever 16 holds the control element 15 with the pin 17 which engages into the guide track 11. The first slide 20 can thus be secured to the housing 9 via a latching mechanism. Alternatively, the lever 16 with the control element can also be arranged on the housing and the guide track 11 on the first slide. Furthermore, the latching mechanism described here can also be exchanged for another latching mechanism with the same function as is known from the prior art.

The second slide 30 can be moved in the opening direction via the first slide 20 until stop elements 55 come to rest on the cover cap 93. Then, the second slide 30 has arrived at an end position and thus also holds the third slide 40 and the ejection element 6 in a slightly opened position.

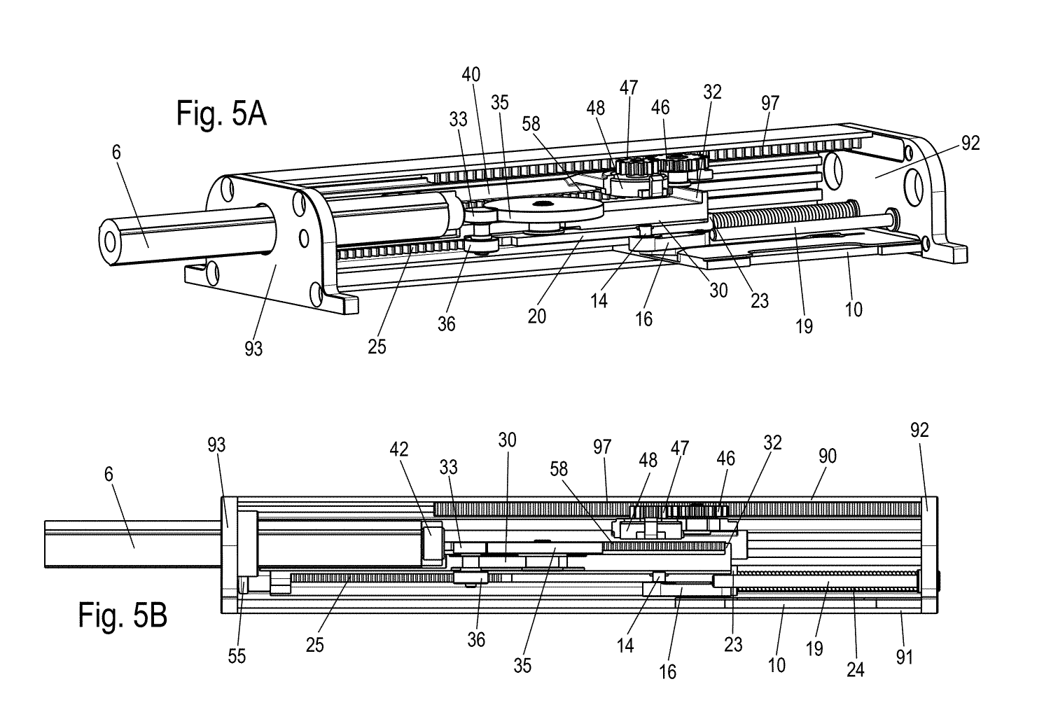

The open position of the ejection device is also shown in FIGS. 5A and 5B. From the open position, the door 3 can be pulled in the opening direction, as a result of which the ejection element 6 is also moved in the opening direction by the coupling with the door 3. As a result, the third slide 40 is moved in the opening direction against the force of the spring 50. Furthermore, a toothed rack 58 is formed on the third slide 40 which is in engagement with a gearwheel 35, which is rotatably mounted on the second slide 30, wherein the gearwheel 35 is movably held in the direction of movement of the second slide 30 on an elongated hole. As a result, the gearwheel 35 can be engaged and decoupled with an adjacent gearwheel 33. When the ejection element 6 is pulled, the toothed rack 58 moves the gearwheel 35 in the opening direction and thus couples it into the gearwheel 33. The gearwheel 33 is connected in a rotationally fixed manner via a shaft 34 to a gearwheel 36 on the underside of the second slide 30. The gearwheel 36 is in turn in engagement with a toothed rack 25, which is formed on the first slide 20. Thus, by rotating the gearwheel 36, the first slide 20 is moved in the closing direction against the force of the energy storage device 24 when the ejection element 6 is pulled in the opening direction. The force transmission by the gearwheels 33, 35 and 36 can be selected in such a way that the opening movement of the door 3 takes place smoothly and nevertheless a tensioning of the energy storage device 24 is made possible.

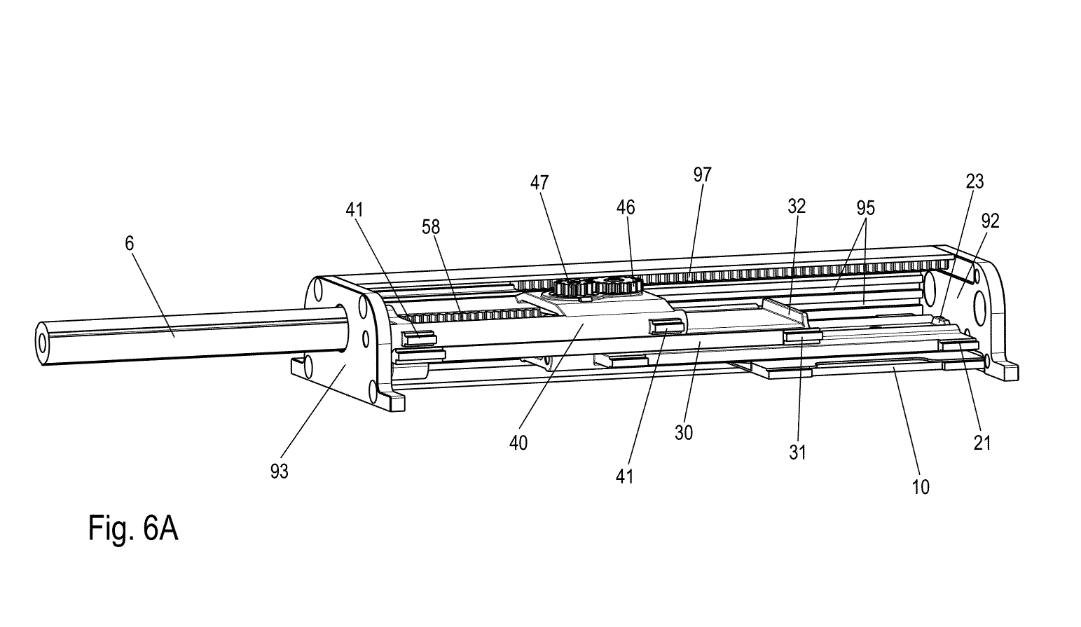

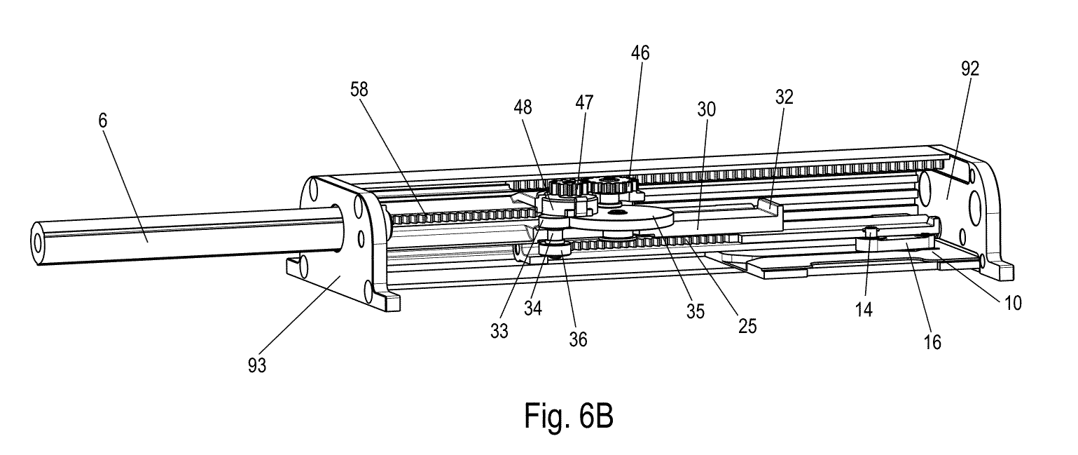

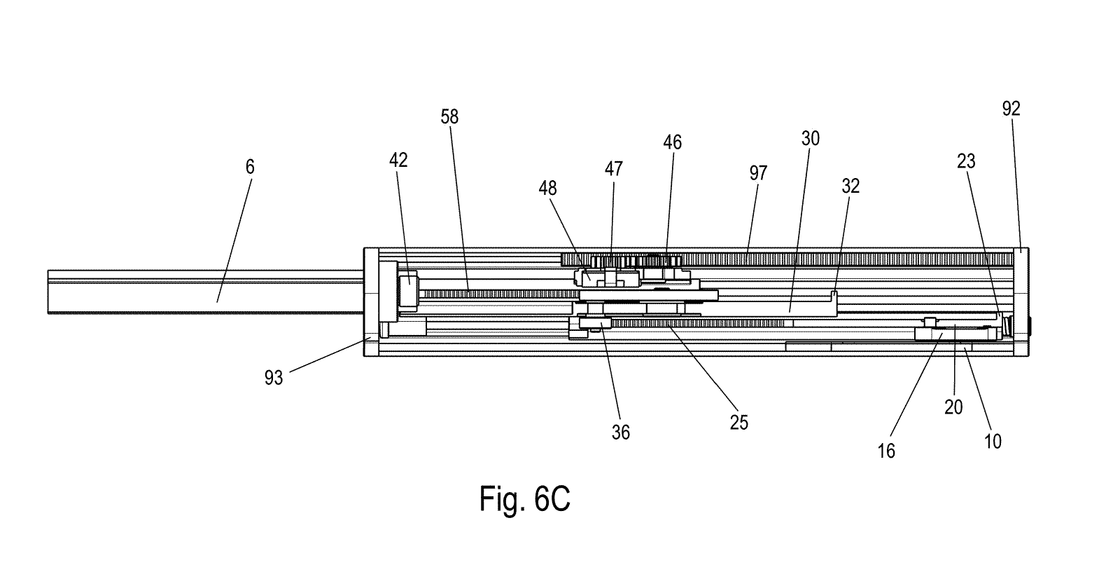

The ejection element 6 is now pulled until the control element 15 with the pin 17 is arranged on the guide track 11 adjacent to a catch recess 13. The third slide 40 now rests against the cover cap 93 with a dividing cam 42, so that the ejection element 6, which is fixed by means of a pin 44 to a threaded sleeve 43 of the dividing cam 42, cannot be moved further in the opening direction, as shown in FIGS. 6A, 6B and 6C. As a result, the releasable coupling is released between the door 3 and the ejection element 6, in particular by magnetic forces. It is, of course, also possible to provide a mechanism for releasably connecting the ejection element 6 to the door 3. This can be provided, for example, by an interlocking connection or by a releasable mechanism.

After releasing the door 3 from the ejection element 6, the ejection element 6 is now moved again in the closing direction because the spring 50 of the retracting device moves the third slide 40 in the closing direction. As a result of the backward movement, the gearwheel 35 is first decoupled from the gearwheel 33 so that no forces are transmitted to the first slide 20 during the backward movement. Furthermore, the gearwheel 46 is rotated by the backward movement along the toothed rack 97 and thus drives the rotary damper 48 via the gearwheel 47, which ensures that the backward movement of the ejection element 6 takes place only at a limited speed. During the return movement, the third slide 40 now moves into the second slide 20 until an end face of the third slide 40 comes to rest against the web-shaped driver 32. In this position, the second slide 30 is also moved in the closing direction until the second slide 30 rests with its end face against the driver 23 of the first slide 20. In the closed position, the ejection element 6 is largely inserted into the housing 9, so that the door 3 can be automatically moved into the closed position, even if damped hinges 4 with self-retraction are used. In the closed position, the door 3 then rests against the ejection element 6 and can slightly push in the ejector element 6 by manually advancing in the closing direction, so that the control element 15 is moved against the force of the energy storage device 24 and thus unlocking takes place, so that renewed ejecting is performed.

In the illustrative embodiment shown, the coupling is effected by means of toothed racks and gearwheels, wherein the position of the toothed racks and gearwheels can be exchanged, e.g. gearwheels may be provided on the third slide instead of the toothed rack in order to provide a corresponding gear. Likewise, toothed racks may be provided on the second slide 30 instead of the illustrated gearwheels, and gearwheels can also be provided on the first slide instead of the toothed rack. In addition, other means for force transmission between the three slides 20, 30 and 40 can also be used.

In the illustrative embodiment shown, the magnet 7 is fixedly connected to the ejection element 6. Such a connection is adequate in the case of linearly movable furniture parts 3 such as a drawer for example. In the case of a movable furniture part 3 which is designed as a door or flap, it may be advantageous to movably mount the magnet, so that the angle position of the door to the linear extension movement of the ejection element 6 can be compensated for. In another embodiment, the driver can be movably formed on the door in order to compensate for the angular position between the door and the magnets. If an interlocking connection or a releasable mechanism is provided between the ejection element 6 and the door 3, these can also be movably mounted in order to compensate for the angular position relative to one another.

In the illustrative embodiment shown, no device is provided between the magnet 7 and the driver on the door, which device reduces a click noise when the door is closed and the driver reaches the magnet 7. This click noise can be advantageous as an acoustic signal or disturbing when an almost silent reaching of the closing position is desired. In the second case, an elastic material can be provided between the magnet 7 and the driver, which may be magnetic. Alternatively, a damper can be used with a short stroke, which can be designed as a linear damper, which can be arranged either on or in the driver, on the ejection element 6 or on the housing 9. The damper is designed such that, when the door 3 is closed, it slows down the tightening of the driver onto the magnet 7, so that almost no click noise occurs. If the damper is arranged on the driver or on the ejection element 6, the damper must also be designed in such a way that it does not actuate the latching mechanism of the ejection device when the door 3 is closed.

In the illustrative embodiment shown, the housing 9 is fixed to the furniture body 2 with the aid of fastening means. However, it may also be provided that a mounting device is fixed on the furniture body 2, onto which the housing 9 of the ejector device is pushed and fixed. The mounting device or the housing 9 may have a depth adjustment so that the position of the housing 9 can be adjusted. Such depth adjustments can be designed as a type of screw adjustment or eccentric adjustment.

The construction of the housing 9 in the embodiment shown here is only illustrative. The housing 9 can also have a different shape, such as a two-shell structure. The housing should fulfill the function of protection of the internal mechanical system.

1. An ejection device for moving a movable furniture part with respect to a furniture body, the ejection device comprising:
an ejection element configured for coupling to the movable furniture part and to selectively move the movable furniture part toward an open position with respect to the furniture body;
an energy storage device configured to actuate the ejection element;
a releasable latching mechanism configured to latch the ejection element and the energy storage device in a closed position;
a tensioning device configured to tension the energy storage device in response to actuation of the ejection element in an opening direction;
a retracting device configured to move the ejection element in a closing direction in response to decoupling the ejection element from the furniture part;
wherein the latching mechanism comprises a first linearly movable slide, the tensioning device comprises a second movable slide the ejection element is connected to a third movable slide, and the second slide and the third slide are movable in the opening direction via the first slide.

2. An ejection device according to claim 1, wherein the second slide can be moved in the closing direction by the retracting device via the third slide.

3. An ejection device according to claim 1, wherein the first slide, the second slide, and the third slide are linearly guided within a common housing.

4. An ejection device according to claim 3, wherein the housing comprises grooves configured to guide the slides within an interior space thereof.

5. An ejection device according to claim 1, wherein the tensioning device comprises a gear for moving the first slide in the closing direction when the third slide is withdrawn in the opening direction.

6. An ejection device according to claim 5, further comprising a clutch configured to decouple the gear thereby enabling movement of the second and third slide in the closing direction.

7. An ejection device according to claim 5, wherein the second slide rests against a stop in the housing in the open position and a gearwheel of the gear can be coupled by moving the third slide in the opening direction.

8. An ejection device according to claim 1, wherein the latching mechanism comprises a guide track having a loop-shaped section with a catch recess into which a control pin engages, wherein the first slide can be latched onto the housing via the latching mechanism.

9. An ejection device according to claim 1, wherein the retracting device comprises a damper.

10. An ejection device according to claim 9, wherein the housing comprises at least one toothed rack in engagement with at least one gearwheel which drives a rotary damper.

11. An ejection device according to claim 1, wherein on the third slide comprises a toothed rack, which drives a gearwheel configured to tension the energy storage device in response to movement of the ejection element out of the open position in the opening direction.

12. An ejection device according to claim 1, wherein the energy storage device comprises at least one linearly guided compression spring.

13. An ejection device according to claim 1, wherein the retracting device for the ejection element comprises an energy storage device imparting a force lower than the force imparted by the energy storage device of the ejection device.

14. An ejection device according to claim 1, wherein the ejection element comprises a magnet which can be coupled by magnetic forces to a driver on a door or flap.

15. A piece of furniture having at least one door or flap which is mounted on hinges and can be moved by means of an ejection device according to claim 1.
